(19) United States
(12) Patent Application Publication
(10) Pub. No.: US 2020/0409732 A1
(43) Pub. Date: Dec. 31, 2020

(54) SHARING MULTIMEDIA PHYSICAL FUNCTIONS IN A VIRTUALIZED ENVIRONMENT ON A PROCESSING UNIT

(71) Applicant: ATI TECHNOLOGIES ULC, Markham (CA)

(72) Inventor: Branko KOVACEVIC, Markham (CA)

(21) Appl. No.: 16/453,664

(22) Filed: Jun. 26, 2019

(51) Int. Cl. G06F 9/455; G06F 9/30; G06F 9/48; G06F 9/38

(52) U.S. Cl. CPC G06F 9/45558; G06F 9/30138; G06F 9/4881; G06T 15/005; G06F 9/3877; G06F 2009/4557; G06F 9/30123

(57) ABSTRACT

A processing unit includes kernel mode units configured to execute a hypervisor and guest virtual machines (VMs) and a set of registers. The processing unit also includes a fixed function hardware block configured to implement a physical function. Virtual functions corresponding to the physical function are exposed to the guest VMs. Subsets of the set of registers are allocated to store information associated with the virtual functions and the fixed function hardware block executes one of the virtual functions for one of the guest VMs based on the information stored in a corresponding one of the subsets. Each subset includes a frame buffer to store frames that are operated on by the virtual function associated with the subset, context registers to define an operating state of the virtual function, and a doorbell register to signal that the virtual function is ready to be scheduled for execution.

### BACKGROUND

Conventional processing systems include a central processing unit (CPU) and a graphics processing unit (GPU) that implements audio, video, and graphics applications. In some cases, the CPU and GPU are integrated into an accelerated processing unit (APU). Multimedia applications are represented as a static programming sequence of microprocessor instructions grouped in a program or as processes (containers) with a set of resources that are allocated to the multimedia application during the lifetime of the application. For example, a Windows® process consists of a private virtual address space, an executable program, a set of handles that map and utilize various system resources (such as semaphores, synchronization objects, and files accessible to threads in the process), a security context (consisting of user identification, privileges, access attributes, user account control flags, sessions, etc.), a process identifier that uniquely identifies client application, and one or more threads of execution. Operating systems (OSs) also support multimedia, e.g., an OS can open a multimedia file encapsulated in a specific container. Examples of multimedia containers include .mov, .mp4, and .ts. The OS locates audio or video containers, retrieves the content, decodes the content in software on CPU or on an available multimedia accelerator, renders the content, and presents the rendered content on a display, e.g., as alpha blended or color keyed graphics. In some cases, the CPU initiates graphics processing by issuing draw calls to the GPU. A draw call is a command that is generated by the CPU and transmitted to the GPU to instruct the GPU render an object in a frame (or a portion of an object). The draw call includes information defining textures, states, shaders, rendering objects, buffers, and the like that are used by the GPU to render the object or portion thereof. The GPU renders the object to produce values of pixels that are provided to a display, which uses the pixel values to display an image that represents the rendered object.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that includes a graphics processing unit (GPU) that implements sharing of physical functions in a virtualized environment according to some embodiments.

FIG. 2 is a block diagram of a system-on-a-chip (SOC) that integrates a central processing unit (CPU) and a GPU on a single semiconductor die according to some embodiments.

FIG. 3 is a block diagram of a first embodiment of a hardware architecture that supports multimedia virtualization on a GPU according to some embodiments.

FIG. 4 is a block diagram of a second embodiment of a hardware architecture that supports multimedia virtualization on a GPU according to some embodiments.

FIG. 5 is a block diagram of an operating system (OS) that is used to support multimedia processing in a virtualized OS ecosystem according to some embodiments.

FIG. 6 is a block diagram of an OS architecture with virtualization support according to some embodiments.

FIG. 7 is a block diagram of a multimedia software system for compressed video decoding, rendering, and presentation according to some embodiments.

FIG. 8 is a block diagram of a physical function configuration space that identifies base address registers (BAR) for physical functions according to some embodiments.

FIG. 9 is a block diagram of a portion of a single root I/O virtualization (SR-IOV) header that identifies BARs for virtual functions according to some embodiments.

FIG. 10 is a block diagram of a lifecycle of a host OS that implements a physical function and guest virtual machines (VMs) that implement virtual functions associated with the physical function according to some embodiments.

FIG. 11 is a block diagram of a multimedia user mode driver and a kernel mode driver according to some embodiments.

FIG. 12 is a first portion of a message sequence that supports multimedia capability sharing in a virtualized OS ecosystem according to some embodiments.

FIG. 13 is a second portion of the message sequence that supports multimedia capability sharing in a virtualized OS ecosystem according to some embodiments.

### DETAILED DESCRIPTION

Processing units such as graphics processing units (GPUs) support virtualization that allows multiple virtual machines to use the hardware resources of the GPU. Each virtual machine executes as a separate process that uses the hardware resources of the GPU. Some virtual machines implement an operating system that allows the virtual machine to emulate an actual machine. Other virtual machines are designed to execute code in a platform-independent environment. A hypervisor creates and runs the virtual machines, which are also referred to as guest machines or guests. The virtual environment implemented on the GPU provides virtual functions to other virtual components implemented on a physical machine. A single physical function implemented in the GPU is used to support one or more virtual functions. The physical function allocates the virtual functions to different virtual machines on the physical machine on a time-sliced basis. For example, the physical function allocates a first virtual function to a first virtual machine in a first time interval and a second virtual function to a second virtual machine in a second, subsequent time interval. In some cases, a physical function in the GPU supports as many as thirty-one virtual functions, although more or fewer virtual functions are supported in other cases. The single root input/output virtualization (SR IOV) specification allows multiple virtual machines to share a GPU interface to a single bus, such as a peripheral component interconnect express (PCIe) bus. Components access the virtual functions by transmitting requests over the bus.

Processing of multimedia content, e.g., by virtual machines executing on a GPU, is accelerated using hardware accelerated functions. For example, hardware accelerated multimedia content handling can be achieved by using applications that are part of a specific OS distribution or that are provided by independent software vendors. To use hardware acceleration, a multimedia application queries the hardware accelerated multimedia functionality of the GPU before starting audio, video, or multimedia playback. The query includes requests for information such as the supported codecs (coder-decoder), a maximum video resolution, and a maximum supported source rate. Separate processes (e.g., separate host or guest virtual machines) are used to execute different instances of the same multimedia application and the multiple instances of the multimedia application executed by the different virtual machines are unaware of each other. In some cases, a user mode driver is unaware how many different instances are running concurrently on the GPU. The user mode driver typically allows only a single instance of a hardware function (such as a codec) to be opened and allocated to a process such as a virtual machine. Consequently, the first application that initiates graphics processing on the GPU, e.g., in a first virtual machine, is allocated fixed function hardware to decode a compressed video bitstream decode. The fixed function hardware is not available for allocation to subsequent applications concurrently with execution of the first application and so a second application executing on a second virtual machine is decoded (or encoded) using software executing on a general-purpose application processor, such as a central processing unit (CPU). Applications executing on other virtual machines are also decoded (or encoded) using software executing on the CPU until the resources (cores and threads) of the CPU are fully occupied. This scenario is power inefficient and often slows down the processing system when higher source resolutions and higher refresh rates are required.

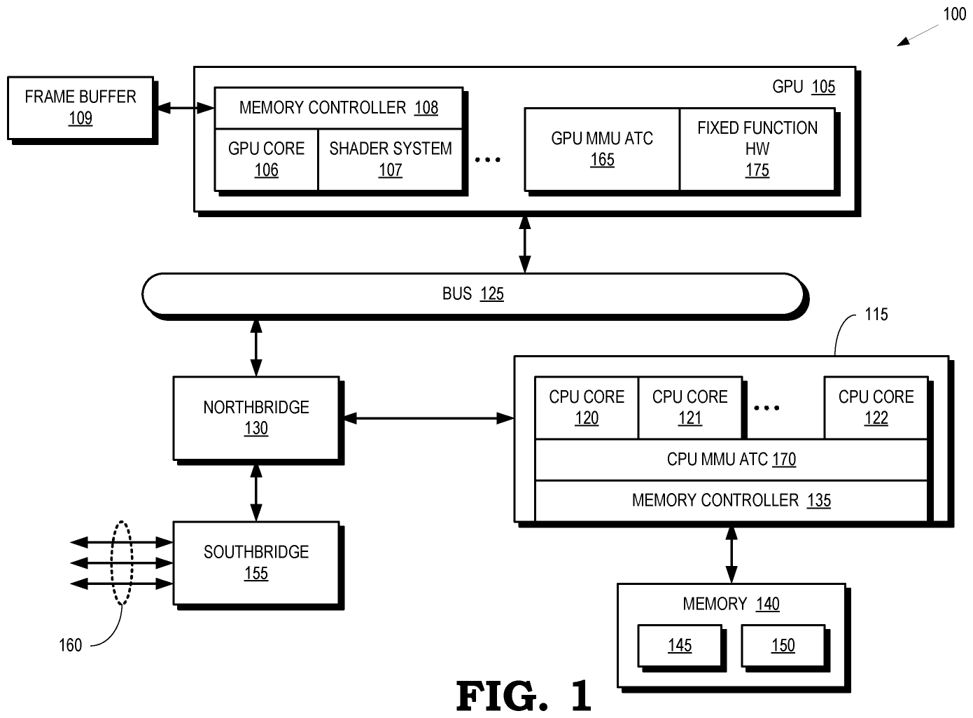

FIGS. 1-13 disclose embodiments of techniques that improve the execution speed of multimedia applications, while reducing power consumption of the processing system, by allowing multiple virtual machines to share the hardware functionality provided by fixed function hardware blocks in a GPU instead of forcing all but one process to use hardware acceleration provided by software executing on a CPU. Hardware acceleration functionality is implemented as a physical function provided by a fixed function hardware block. In some embodiments, the physical function performs encoding of a multimedia data stream, decoding of multimedia data stream, encoding/decoding of audio or video data, or other operations. A plurality of virtual functions corresponding to the physical function are exposed to guest virtual machines (VMs) executing on the GPU. The GPU includes a set of registers and subsets of the registers are allocated to store information associated with different virtual functions. The number of subsets, as well as the number of registers in the subset, is set to a static value corresponding to a maximum amount of space used by each virtual function or an initial value corresponding to a minimum amount of space used by each virtual function, which is subsequently dynamically modified based on properties of the virtual function. In some embodiments, each subset of registers includes a frame buffer to store the frames that are operated on by the virtual functions, context registers to define the operating state of the virtual functions, and a doorbell to signal that the virtual function is ready to be scheduled for execution by the GPU, e.g., using one or more compute units of the GPU.

A hypervisor grants or denies access to the registers to one guest VM at a time. The guest VM that has access to the registers performs graphics rendering on the frames stored in the frame buffer in the subset of the registers for the guest VM. A fixed function hardware block on the GPU is configured to execute a virtual function for the guest VM based on the information stored in the context registers in the subset of the registers for the guest VM. In some embodiments, configuration of the fixed function hardware block includes installing a user mode driver and firmware image of the multimedia functionality used to implement the virtual function. The guest VM signals that it is ready to be scheduled for execution by writing information to the doorbell registers in the subset. A scheduler in the GPU schedules the guest VM to execute the virtual function at a scheduled time. In some embodiments, the guest VM is scheduled based on a priority associated with the guest VM and other priorities associated with other guest VMs that are ready to be scheduled. A world switch is performed at the scheduled time to switch contexts from a context defined for a previously executing guest VM to a context for the current guest VM, e.g., as defined in the context registers in the subset of the registers for the current guest VM. In some embodiments, the world switch includes installing a user mode driver and firmware image of the multimedia functionality used to implement the virtual function on the GPU. After the world switch is complete, the current guest VM begins executing the virtual function to perform hardware acceleration operations on the frames in the frame buffer registers. As discussed herein, examples of the hardware acceleration operations include multimedia decoding, multimedia encoding, video decoding, video encoding, audio decoding, audio encoding, and the like. The scheduler schedules the guest VM for a time interval and the guest VM has exclusive access to the virtual function and the subset of registers during the time interval. In response to completing execution during the time interval, the guest VM notifies the hypervisor that another virtual function can be loaded for another guest VM and the doorbell for the guest VM is cleared.

FIG. 1 is a block diagram of a processing system 100 that includes a graphics processing unit (GPU) 105 that implements sharing of physical functions in a virtualized environment according to some embodiments. The GPU 105 includes one or more GPU cores 106 that independently execute instructions concurrently or in parallel and one or more shader systems 107 that support 3D graphics or video rendering. For example, the shader system 107 can be used to improve visual presentation by increasing graphics rendering frame-per-second scores or patching areas of rendered images where a graphics engine did not accurately render the scene. A memory controller 108 provides an interface to a frame buffer 109 that stores frames during the rendering process. Some embodiments of the frame buffer 109 are implemented as a dynamic random access memory (DRAM). However, the frame buffer 109 can also be implemented using other types of memory including static random access memory (SRAM), nonvolatile RAM, and the like. Some embodiments of the GPU 105 include other circuitry such as an encoder format converter, a multiformat video codec, display output circuitry that provides an interface to a display or screen, and audio coprocessor, an audio codec for encoding/decoding audio signals, and the like.

The processing system 100 also includes a central processing unit (CPU) 115 for executing instructions. Some embodiments of the CPU 115 include multiple processor cores 120, 121, 122 (collectively referred to herein as “the CPU cores 120-122”) that can independently execute instructions concurrently or in parallel. In some embodiments, the GPU 105 operates as a discrete GPU (dGPU) that is connected to the CPU 115 via a bus 125 (such as a PCI-e bus) and a northbridge 130. The CPU 115 also includes a memory controller 130 that provides an interface between the CPU 115 and a memory 140. Some embodiments of the memory 140 are implemented as a DRAM, an SRAM, nonvolatile RAM, and the like. The CPU 115 executes instructions such as program code 145 stored in the memory 115 and the CPU 115 stores information 150 in the memory 140 such as the results of the executed instructions. The CPU 115 is also able to initiate graphics processing by issuing draw calls to the GPU 105. A draw call is a command that is generated by the CPU 115 and transmitted to the GPU 105 to instruct the GPU 105 render an object in a frame (or a portion of an object).

A southbridge 155 is connected to the northbridge 130. The southbridge 155 provides one or more interfaces 160 to peripheral units associated with the processing system 100. Some embodiments of the interfaces 160 include interfaces to peripheral units such as universal serial bus (USB) devices, General Purpose I/O (GPIO), SATA for hard disk drive, serial peripheral bus interfaces like SPI, I2C, and the like.

The GPU 105 includes a GPU virtual memory management unit with address translation controller (GPU MMU ATC) 165 and the CPU 115 includes a CPU MMU ATC 170. The GPU MMU ATC 165 and the CPU MMU ATC 170 provide translation of virtual memory address (VA) to physical memory address (PA) by using a multilevel translation logic and a set of translation tables maintained by operating system kernel mode driver (KMD). Thus, application processes that execute on main OS or in the guest OS each have their own virtual address space for CPU operations and GPU rendering. The GPU MMU ATC 165 and the CPU MMU ATC 170 therefore support virtualization of GPU and CPU cores. The GPU 105 has its own memory management unit (MMU) which translates per-process GPU virtual addresses to physical addresses. Each process has separate CPU and GPU virtual address spaces that use distinct page tables. The video memory manager manages the GPU virtual address space of all processes and oversees allocating, growing, updating, ensuring residency of memory pages and freeing page tables.

Some embodiments of the GPU 105 share address space and page table/page directory with the CPU 115 and can therefore operate in the System Virtual Memory Mode (IOMMu). In the GPU MMU model, Video Memory Manager (VidMM) in OS kernel manages GPU MMU ATC 165 and page tables while exposing Device Driver Interface (DDI) services to the user mode driver (UMD) for GPU virtual address mapping. In the IOMMU model, the GPU 105 and CPU 115 share the common address space, common page directories, and page tables. This model is known as (full) System Virtual Memory (SVM). Some embodiments of APU hardware support:
A first MMU unit for GPU 105 access to GPU memory and CPU system memory.
A second MMU unit for CPU 115 access to CPU memory and GPU system memory.
   Similarly, in some embodiments, discrete GPU HW has its own GPU MMU ATC 165 and a discrete CPU multicore system has its own CPU MMU with ATC 170. MMU units with ATC maintains separate page tables for CPU and GPU access for each and every virtual machine/guest OS resulting with each guest OS with its own set of system and graphics memory.

Some embodiments of the processing system 100 implement a Desktop Window Manager (DWM) to perform decode, encode, compute, and/or rendering jobs, which are submitted to the GPU 105 directly from user mode. The GPU 105 exposes and manages the various user mode queues of work, eliminating the need for the video memory manager (VidMM) to inspect and patch every command buffer before submission to a GPU engine. As a positive consequence, packet-based scheduling can be batch—based (allowing more back-to-back jobs to be submitted via queue system at the unit of time) allowing central processor unit (CPU) to operate at low power levels, consuming minimal power. Other benefits of implementing some embodiments of the GPU and ATC 165 and the CPU MMU ATC 170 include the ability to scatter virtual memory allocations, which can be fragmented in non-continuous GPU or CPU memory space. Moreover, there is no need for CPU memory address patching and no need to track memory references inside GPU command buffers through allocation and patch location lists, or to patch those buffers with the correct physical memory reference before submission to a GPU engine

The GPU 105 also includes one or more fixed function hardware blocks 175 that implement a physical function. In some embodiments, the physical function implemented in the fixed function hardware block 175 is a hardware acceleration function such as multimedia decoding, multimedia encoding, video decoding, video encoding, audio decoding, and audio encoding. The virtual environment implemented in the memory 115 supports a physical function and a set of virtual functions exposed to the guest VMs. The GPU 105 further includes a set of registers (not shown in FIG. 1 in the interest of clarity) that store information associated with processing performed by kernel mode units. Subsets of the set of registers are allocated to store information associated with the virtual functions. The fixed function hardware block 175 executes one of the virtual functions for one of the guest VMs based on the information stored in a corresponding one of the subsets, as discussed in detail herein.

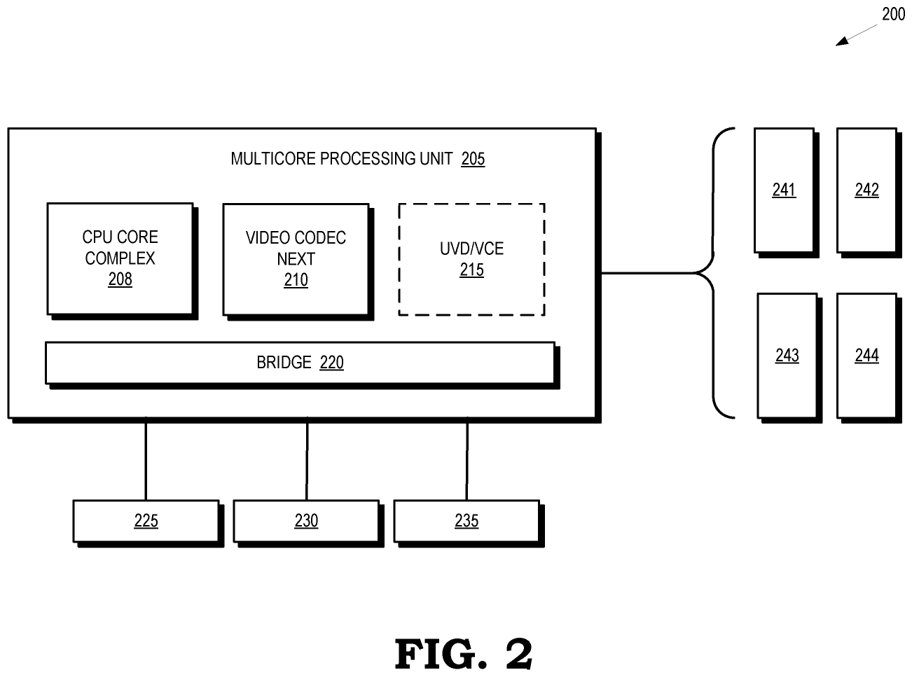

FIG. 2 is a block diagram of a system-on-a-chip (SOC) 200 that integrates a CPU and the GPU on a single semiconductor die according to some embodiments. The SOC 200 includes a multicore processing unit 205 that implements sharing of physical functions in a virtualized environment, as discussed herein. The multicore processing unit 205 includes a CPU core complex 208 formed of one or more CPU cores that independently execute instructions concurrently or in parallel. In the interest of clarity, the individual CPU cores are not shown in FIG. 2.

The multicore processing unit 205 also includes circuitry for encoding and decoding data such as multimedia data, video data, audio data, and combinations thereof. In some embodiments, the encoding/decoding (codec) circuitry includes a video codec next (VCN) 210 that is controlled by a dedicated video reduced instruction set computing processor (RISC). In other embodiments, codec circuitry includes a universal video decoder (UVD)/video compression engine (VCE) 215 that is implemented as a fixed hardware IP controlled by a dedicated RISC processor, which may be the same or different than the RISC processor used to implement the VCN 210. The VCN 210 and the UVD/VCE 215 are alternate implementations of the encoding/decoding circuitry and the illustrated embodiment of the multicore processing unit 205 is implemented using the VCN 210 and does not include the UVD/VCE 215, as indicated by the dashed box representing the UVD/VCE 215. Firmware is used to configure the VCN 210 and the UVD/VCE 215. Different firmware configurations associated with different guest VMs are stored in subsets of registers associated with the guest VMs to facilitate world switches between the guest VMs, as discussed in detail below.

The multicore processing unit 205 also includes a bridge 220 such as a southbridge that is used to provide an interface between the multicore processing unit 205 and interfaces to peripheral devices. In some embodiments, the bridge 220 connects the multicore processing unit 205 to one or more PCIe interfaces 225, one or more Universal serial bus (USB) interfaces 230, and one or more serial AT attachment (SATA) interfaces 235. Slots 240, 241, 242, 243 are provided for attaching memory elements such as double data rate (DDR) memory integrated circuits that store information for the multicore processing unit 205.

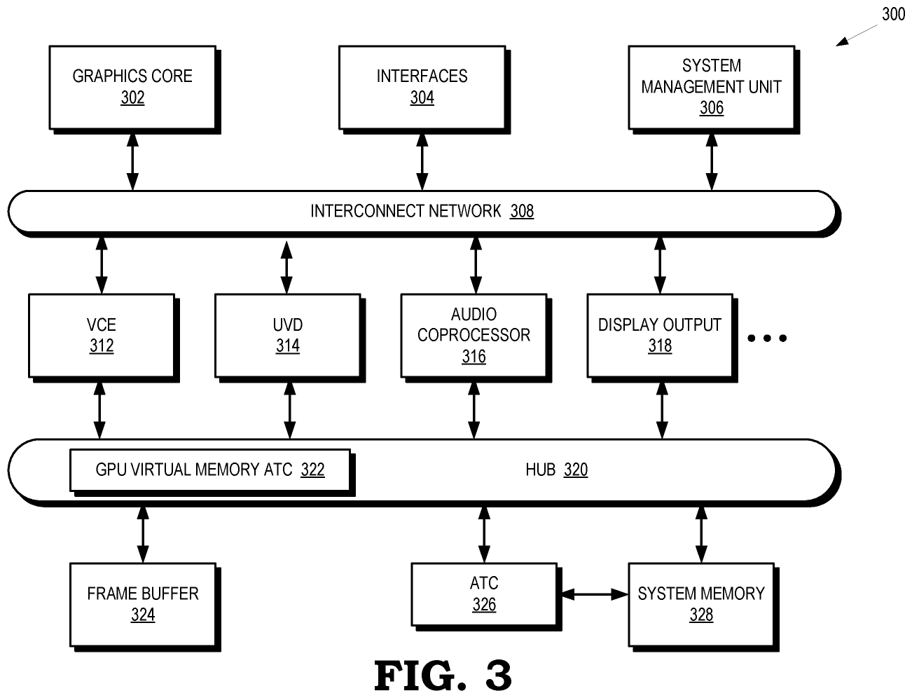

FIG. 3 is a block diagram of a first embodiment of a hardware architecture 300 that supports multimedia virtualization on a GPU according to some embodiments. The hardware architecture 300 includes a graphics core 302 that includes compute units (or other processors) to execute instructions concurrently or in parallel. In some embodiments, the graphics core 302 includes integrated address translation logic for virtual memory management. The graphics core 302 uses flexible data routing to do rendering operations such as performance rendering using a local memory or by accessing content in a system memory for coordinated CPU/GPU graphics processing.

The hardware architecture 300 also includes one or more interfaces 304. Some embodiments of the interfaces 304 include a platform component interface to platform components such as voltage regulators, pinstripes, flash memory, embedded controllers, southbridges, fan control, and the like. Some embodiments of the interface 304 include an interface to a Joint Test Action Group (JTAG) interface, a boundary scan diagnostics (BSD) scan interface, and a debug interface. Some embodiments of the interface 304 include a display interface to one or more external display panels. The hardware architecture 300 further includes a system management unit 306 that manages thermal and power conditions for the hardware architecture 300.

An interconnect network 308 is used to facilitate communication with the graphics core 302, the interface 304, the system management unit 306, and other entities attached to the interconnect network 308. Some embodiments of the interconnect network 308 are implemented as a scalable control fabric or a system management network that provides register access and access to local data and instruction memory of fixed hardware for initialization, firmware loading, runtime control, and the like. The interconnect network 308 is also connected to a Video Compression Engine (VCE) 312, a Universal Video Decoder (UVD) 314, an audio coprocessor 316, and a display output 318, as well as other entities such as direct memory access, hardware semaphore logic, display controllers, and the like, which are not shown in FIG. 3 in the interest of clarity.

Some embodiments of the VCE 312 are implemented as a compressed bitstream video encoder that is controlled using firmware executing on a local video-RISC. The VCE 312 is multi-format capable, e.g., the VCE 312 encodes H.264, H.265, AV1, and other encoding or compression formats using various profiles and levels. The VCE 312 encodes from a provided YUV surface or an RGB surface with color space conversion. In some embodiments, color space conversion and video scaling are executed on a GPU core executing a pixel shader or a compute shader. In some embodiments, color space conversion and video scaling are performed on a fixed function hardware video preprocessing block (not shown in FIG. 3 in the interest of clarity).

Some embodiments of the UVD 314 are implemented as a compressed bitstream video decoder that is controlled from firmware running on the local video-RISC. The UVD 314 is multi-format capable, e.g., the UVD 314 decodes legacy MPEG-2, MPEG-3, and VC1 bitstreams, as well as newer H.264, H.265, VP9, and AV1 formats at various profiles, levels, and bit depths.

Some embodiments of the audio coprocessor 316 perform host audio offload with local and global audio capture and rendering. For example, the audio coprocessor 316 can perform audio format conversion, sample rate conversion, audio equalization, volume control, and mixing. The audio coprocessor 316 can also implement algorithms for audio video conferencing and computer controlled by voice such as keyword detection, acoustic echo cancellation, noise suppression, microphone beamforming, and the like.

The hardware architecture 300 includes a hub 320 for controlling individual fixed function hardware blocks. Some embodiments of the hub 320 include a local GPU virtual memory address translation cache (ATC) 322 that is used to perform address translation from virtual addresses to physical addresses. The local GPU virtual memory ATC 322 supports CPU register access and data passing to and from a local frame buffer 324 or an array of buffers stored in a system memory.

A multilevel ATC 326 stores translations of virtual addresses to physical addresses to support performing address translation. In some embodiments, the address translations are used to facilitate access to the local frame buffer 324 and a system memory 328.

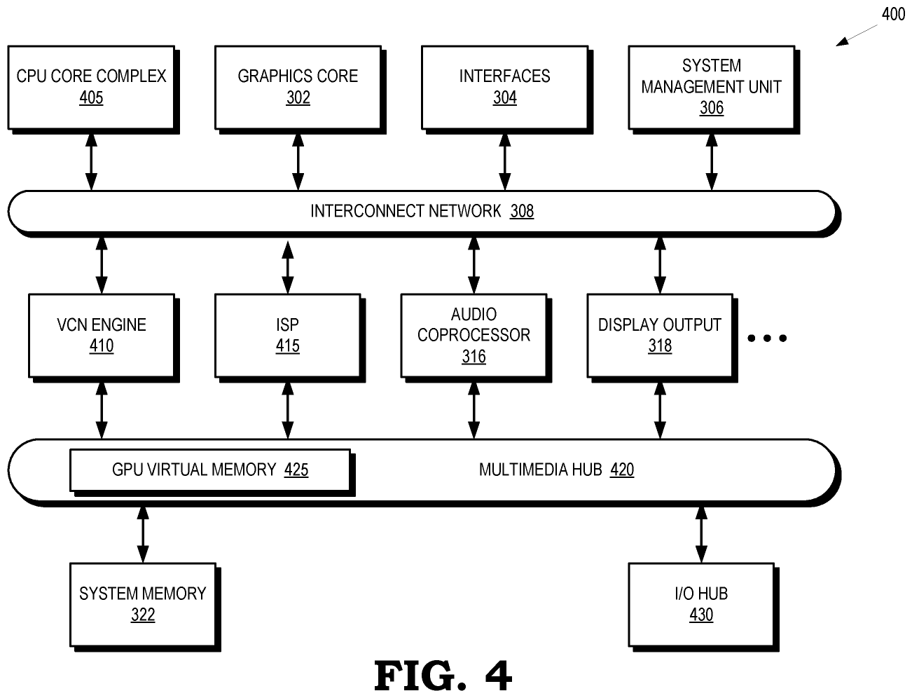

FIG. 4 is a block diagram of a second embodiment of a hardware architecture 400 that supports multimedia virtualization on a GPU according to some embodiments. The hardware architecture 400 includes some of the same elements as the first embodiment of the hardware architecture 300 shown in FIG. 3. For example, the hardware architecture 400 includes a graphics core 302, interfaces 304, a system management unit 306, an interconnect network 308, an audio coprocessor 316, a display output 318, and system memory 328. These entities operate in the same or an analogous manner as the corresponding entities in the hardware architecture 300 shown in FIG. 3.

The second embodiment of the hardware architecture 400 differs from the first embodiment of the hardware architecture 300 shown in FIG. 3 by including a CPU core complex 405, a VCN engine 410, an image signal processor (ISP) 415, and a multimedia hub 420.

Some embodiments of the CPU core complex 405 are implemented as a multicore CPU system with a multilevel cache that has access to the system memory 328. The CPU core complex 405 also includes functional blocks (not shown in FIG. 4 in the interest of clarity) to perform initialization, set up, status servicing, interrupt processing, and the like.

Some embodiments of the VCN engine 410 include a multimedia video subsystem that includes an integrated compressed video decoder and video encoder. The VCN engine 410 is implemented as a video RISC processor that is configured using firmware to perform priority-based decoding and encoder scheduling. A firmware scheduler uses a set of hardware assisted queues to submit decoding and encoding jobs to a kernel mode driver. For example, firmware executing on the VCN engine 410 uses a decoding queue running at a normal priority queue and encoding queues running at normal, real time, and time critical priority levels. Other parts of VCN engine 410 include:
a. Legacy MPEG-2, MPEG-4 and VC-1 decoder with fixed hardware IP blocks for hardware accelerated Reverse Entropy, Inverse Transform, Motion Predictor, De-blocker decoding processing steps and Register Interface for setup and control.
b. H.264, H.265 and VP9 encoder and decoder subsystem with fixed hardware IP blocks for hardware accelerated Reverse Entropy, Integer Motion Estimation, Entropy Coding, Inverse Transform and Interpolation, Motion Prediction and Interpolation and Deblocking encode and decode processing steps with Register Interface for setup and control and Context Management of hardware states of fixed hardware IP blocks and Memory data Manager with Memory Interface that supports transfer of compressed bit stream to and from Locally Connected Memory and graphics Memory with dedicated Memory Controller Interface.
c. JPEG Decoder and JPEG encoder implemented as fixed hardware function under Video RISC processor control.
d. Set of registers for JPEG decode/encode, video CODEC and for video RISC processor.
e. Ring Buffer Controller with a set of circular buffers with write transfer supported by hardware and read transfer supported by Video RISC Processor. Circular Buffers support JPEG decode, Video decode, General Purpose encode (for transcoding use case), Real Time encode (for video conferencing use case) and Time Critical encode for Wireless Display.

Some embodiments of the ISP 410 capture individual frames or video sequences from sensors via an interface such as a Mobile Industry Processor Interface (MIPI) Alliance Camera Interface (CSI-2). Thus, the ISP 410 provides input video or input still pictures. The ISP 410 performs image acquisition, processing, and scaling on acquired YCbCr surfaces. Some embodiments of the ISP 410 support multiple cameras concurrently to perform image processing by switching cameras connected via the MIPI interface to a single internal pipeline. In some cases, functionality of the ISP 410 is bypassed for RGB or YCbCr image surfaces processed by a graphics compute engine. Some embodiments of the ISP 410 implement image processing functions such as de-mosaic, noise reduction, scaling, and transfer of the acquired image/video to and from memory using an internal direct memory access (DMA) engine.

The multimedia hub 420 supports access to the system memory 328 and interfaces such as the I/O hub 430 for accessing peripheral input/output (I/O) devices such as USB, SATA, general purpose I/O (GPIO), real time clocks, SMBUS interfaces, serial I2C interfaces for accessing external configurable flash memories, and the like. Some embodiments of the multimedia hub 420 include a local GPU virtual memory ATC 425 that is used to perform address translation from virtual addresses to physical addresses. The local GPU virtual memory ATC 425 supports CPU register access and data passing to and from a local frame buffer or an array of buffers stored in the system memory 322.

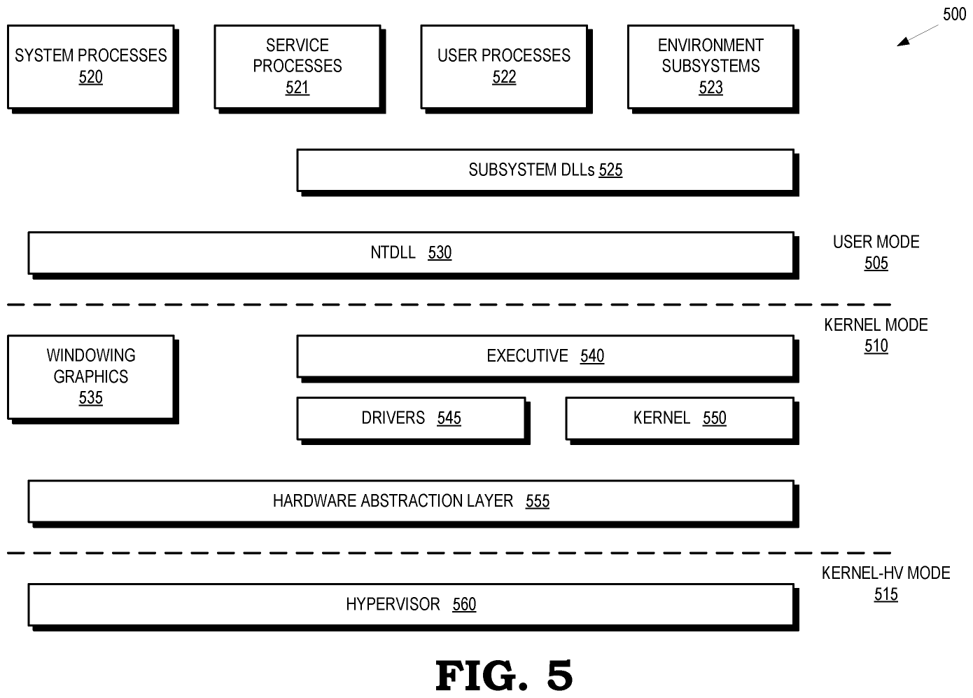

FIG. 5 is a block diagram of an operating system (OS) 500 that is used to support multimedia processing in a virtualized OS ecosystem according to some embodiments. The OS 500 is implemented in the first embodiment of the hardware architecture 300 shown in FIG. 3 and the second embodiment of the hardware architecture 400 shown in FIG. 4.

The OS 500 is divided into a user mode 505, a kernel mode 510, and a portion 515 for the kernel mode in hypervisor (HV) context. A user mode thread is executing a private process address space. Examples of user mode threads include system processes 520, service processes 521, user processes 522, and environmental subsystems 523. The system processes 520, the service processes 521, and the user processes 522 communicate with a subsystem dynamic link library (DLL) 525. When a process executes, it passes through different states (start, ready, running, waiting, and exiting or terminating). An OS process is defined as an entity that represents the basic unit of work implemented in the system for initializing and running the OS 500. Operating system service processes are responsible for the management of platform resources, including the processor, memory, files, and input and output. The OS processes generally shield applications from the implementation details of the of the computer system. Operating system service processes run as:
Kernel services that create and manage processes and threads of execution, execute programs, define and communicate asynchronous events, define and process system clock operations, implement security features, manage files and directories, and control input/output processing to and from peripheral devices.
Utility services to compare, print, and display file contents, edit files, search patterns, evaluate expressions, log events and messages, move files between directories, sort data, execute command scripts, control printers, and access environment information.
Batch processing services to queue work (jobs) and manage the sequencing of processing based on job control commands and data instruction lists.
File and directory synchronization services for management of local and remote copies of files and directories.

User processes run user defined programs and execute user code. The OS environment or integrated applications environment is the environment in which users run application software. The OS environment rests between the OS and the application and consists of a user interface provided by an applications manager and an application programming interface (API) to the applications manager between the OS and the application. An OS environment variable is a dynamic value that the operating system and other software uses to determine specific information like a location on a computer, a version number of a file, a list of file or device objects, etc. Two types of environment variables are user environment variables (specific to user programs or user supplied device drivers) and system environment variables. An NTDLL.DLL layer 530 exports the Windows Native API interface used by user-mode components of the operating system that run without support from Win32 or other API subsystems.

The separation between user mode 505 and kernel mode 510 provides OS protection from erroneous or malicious user mode code. The kernel mode 510 includes a windowing and graphics block 535, an executive function 540, one or more device drivers 545, one or more kernel mode drivers 550, and a hardware abstraction layer 555. The second dividing line separates kernel mode driver 550 in the kernel mode 510 from an OS hypervisor 560 that runs with the same privilege level (level 0) as the kernel but uses specialized CPU instructions to isolate itself from the kernel while monitoring kernel and applications. This is referred to as the hypervisor running at ring −1.

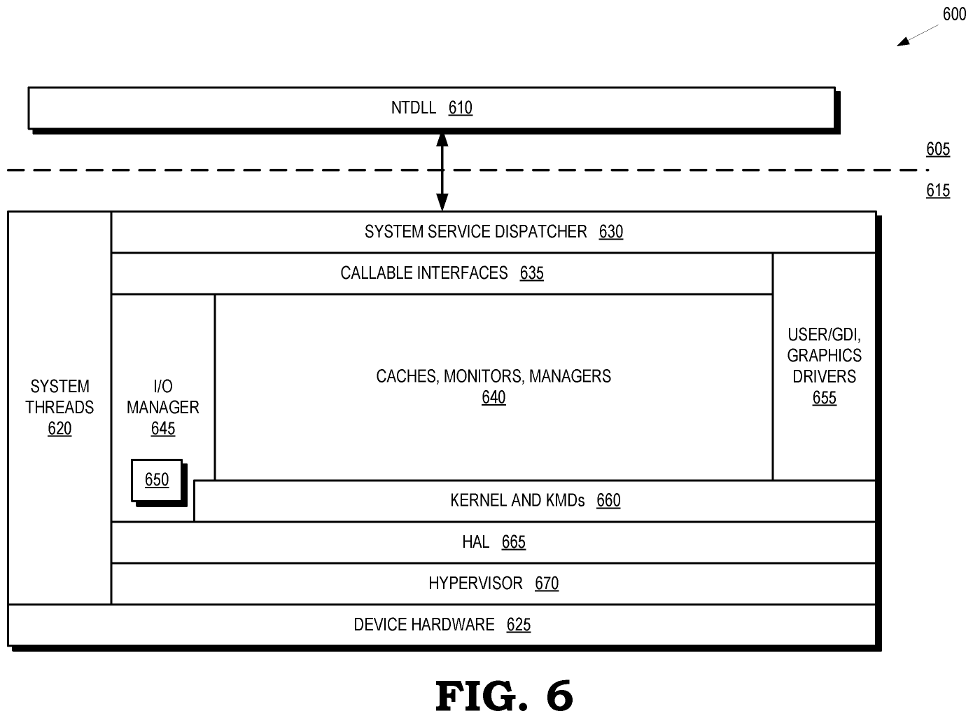

FIG. 6 is a block diagram of an operating system (OS) architecture 600 with virtualization support according to some embodiments. The OS architecture 600 is implemented in some embodiments of the OS 500 shown in FIG. 5. The OS architecture 600 is divided into a user mode 605 that includes an NTDLL layer 610 (as discussed above with regard to FIG. 5) and a kernel mode 615. Some embodiments of the OS architecture 600 implement Kernel Local Inter-Process Communication or Local Procedure Call or Lightweight Procedure Call (LPC), which is an internal, inter-process communication (IPC) facility implemented in the kernel for lightweight IPC between processes on the same computer. In some cases, LPC is replaced by Asynchronous Local Inter-Process Communication with a high-speed scalable communication mechanism for implementation of User-Mode Driver Framework (UMDF), whose user-mode parts require an efficient communication channel with UMDF's components in the kernel.

A framework of the kernel mode 610 includes one or more system threads 620 that interact with device hardware 625 such as a CPU, a BIOS/ACPI, buses, I/O devices, interrupts, timers, memory cache control, and the like. A system service dispatcher 630 interacts with the NTDLL layer 610 in the user mode 605. The framework also includes one or more callable interfaces 635.

The kernel mode 610 further includes functionality to implement caches, monitors, and managers 640. Examples of the caches, monitors, and managers 640 include:
Kernel Configuration Manager that stores configuration values in “INI” (initialization) files and manages persistent registry.
Kernel Object Manager that manages the lifetime of OS resources (files, devices, threads, processes, events, mutexes, semaphores, registry keys, jobs, sections, access tokens, and symbolic links).
Kernel Process Manager that handles the execution of all threads in a process.
Kernel Memory Manager that provides a set of system services that allocate and free virtual memory, share memory between processes, map files into memory, flush virtual pages to disk, retrieve information about the range of virtual pages, change the protection level of virtual pages and lock/unlock virtual pages into memory. At the user mode 605, most of these services are exposed as an API for virtual memory allocations and deallocations, heap APIs, local and global APIs, and APIs for manipulation of memory mapped files for mapping files as memory and sharing memory handles between processes.
Kernel Plug and Play (PnP) Manager that recognizes when a device is added or removed to and from the running computer system and provides device detection and enumeration. Through its lifecycle, the PnP manager maintains the Device Tree that keeps track of the devices in the system.
Kernel Power Manager that manages the change in power status for all devices that support power state changes. The power manager depends on power policy management to handle power management and coordinate power events, and then generates power management event-based procedure calls. The power manager collects requests to change the power state, decides which order the devices must have their power state changed, and then sends the appropriate requests to tell the appropriate drivers to make the changes. The policy manager monitors activity in the system and integrates user status, application status, and device driver status into power policy.
Kernel Security Reference Monitor that provides routines for device drivers to work with kernel access control defined with Access Control Lists (ACLs). It assures that the device drivers' requests are not violating system security policies.

The kernel mode 610 also includes a kernel I/O manager 645 that manages the communication between applications and the interfaces provided by device drivers. Communication between the operating system and device drivers is done through I/O request packets (IRPs) passed from operating system to specific drivers and from one driver to another. Some embodiments of the kernel I/O manager 645 implement file system drivers and device drivers 650. Kernel File System Drivers modify the default behavior of a file system by filtering I/O operations (create, read, write, rename, etc.) for one or more file systems or file system volumes. Kernel Device Drivers receive data from applications, filter the data, and pass it to a lower-level driver that supports device functionality. Some embodiments of the kernel-mode drivers conform to the Windows Driver Model (WDM). Kernel device drivers provide a software interface to hardware devices, enabling operating systems and other user mode programs to access hardware functions without needing to know precise details about the hardware being used. Virtual device drivers are a special variant of device drivers used to emulate a hardware device in virtualization environments. Throughout the emulation, virtual device drivers allow the guest operating system and its drivers running inside a virtual machine to access real hardware in time multiplexed sessions. Attempts by a guest operating system to access the hardware are routed to the virtual device driver in the host operating system as, e.g., function calls.

The kernel mode 615 also includes an OS component 655 that provides core functionality for building simple user interfaces for window management (create, resize reposition, destroy), title bars and menu bars, message passing, input processing and standard controls like buttons, pull down menus, edit boxes, short cut keys etc. The OS component 655 includes a graphics driver interface (GDI), which is based on a set of handles to windows, message, and message loops. The OS component 655 also includes a graphics driver kernel component that controls graphics output by implementing a graphics Device Driver Interface (DDI). The graphics driver kernel component supports initialization and termination, floating point operations, graphics driver functions, creation of device dependent bitmaps, graphics output functions for drawing lines and curves, drawing and filling, copying bitmaps, halftoning, image color management, graphics DDI color and palette functions, and graphics DDI font and text functions. Graphics driver supports the entry points (e.g., as called by GDI) to enable and disable the driver.

The kernel mode 615 includes kernel and kernel mode drivers 660. A graphics kernel driver does not manipulate hardware directly. Instead, the graphics kernel driver calls functions in a hardware abstraction layer (HAL) 665 to interface with the hardware. The HAL 665 supports OS portability to a variety of hardware platforms. Some embodiments of the HAL 665 are implemented as a loadable kernel-mode module (Hal.dll) that enables the same operating system to run on different platforms with different processors. In the illustrated framework, a hypervisor 670 is implemented between the HAL 665 and the device hardware 625.

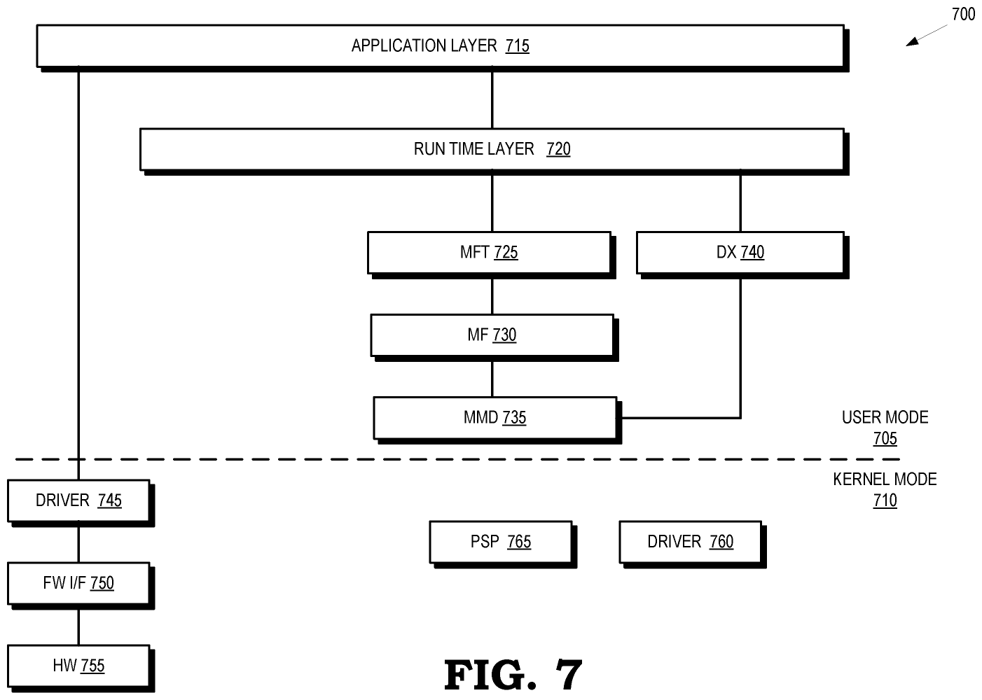

FIG. 7 is a block diagram of a multimedia software system 700 for compressed video decoding, rendering, and presentation according to some embodiments. The multimedia software system 700 is implemented in the first embodiment of the hardware architecture 300 shown in FIG. 3 and the second embodiment of the hardware architecture 400 shown in FIG. 4. The multimedia software system 700 is divided into a user mode 705 and a kernel mode 710.

The user mode 705 of the multimedia software system 700 includes an application layer 715. Some embodiments of the application layer 715 execute applications such as metro applications, modern applications, immersive applications, store applications, and the like. The application layer 715 interacts with a runtime layer 720, which provides connection to other layers and drivers that are used to support multimedia processes, as discussed below.

A hardware media foundation transform (MFT) 725 is implemented in the user mode 705. The MFT 725 is an optional interface available for application programmers. In some embodiments, a separate instance of the MFT 725 is provided for each decoder and encoder. The MFT 725 provides a generic model for processing media data and is used for decoders and encoders that, in MFT representation, have one input and one output stream. Some embodiments of the MFT 725 implement a processing model that is based on a previously defined application programming interface (API) with full underlying hardware abstraction.

A media foundation (MF) layer 730 implemented in the user mode 705 is used to provide a media software development kit (SDK) for the multimedia software system 700. The media SDK defined by the MF layer 730 is a media application framework that allows application programmers to access the CPU and compute shaders implemented in a GPU, and hardware accelerators for media processing such as accelerator functionality are implemented as a physical function provided by a fixed function hardware block. Examples of accelerator functionality implemented by the physical function include encoding of a multimedia data stream, decoding of the multimedia data stream, encoding/decoding of audio or video data, or other operations. In some embodiments, the media SDK includes programming samples that illustrate how to implement video playback, video encoding, video transcoding, remote display, wireless display, and the like.

A multimedia user mode driver (MMD) 735 provides an internal, OS agnostic API set for the MF layer 730. Some embodiments of the MMD 735 are implemented as a C++ based driver that abstracts hardware used to implement the processing system that executes the multimedia software system 700. The MMD 735 interfaces with one or more graphics pipelines (DX) 740 such as DirectX9 and DirectX11 pipelines that include components to allocate memory, video services, or graphics surfaces with different properties. In some cases, the MMD 735 operates under particular OS ecosystems because it incorporates OS-specific implementations.

The kernel mode 710 includes a kernel mode driver 745 that supports hardware acceleration and rendering of a 3D graphics pipeline. Some embodiments of the 3D graphics pipeline include, among other elements, an input assembler, a vertex shader, a tessellator, a geometry shader, a rasterizer, a pixel shader, and output merging of rendered memory resources such as surfaces, buffers, and textures. Elements of the 3D pipeline are implemented as software-based shaders and fixed function hardware.

A firmware interface 750 is used to provide firmware for configuring hardware 755 that is used to implement accelerator functions. Some embodiments of the hardware 755 are implemented as a dedicated video RISC processor that receives instructions and commands from the user mode 710 via the firmware interface 750. The firmware is used to configure one or more of a UVD, VCE, and VCN such as the fixed function hardware blocks 155 shown in FIG. 1, the VCN 210 shown in FIG. 2, the UVD/VCE 215 shown in FIG. 2, the VCE 312 shown in FIG. 3, the UVD 314 shown in FIG. 3, and the VCN engine 410 shown in FIG. 4. The commands received over the firmware interface 750 are used to initialize and prepare the hardware 755 for video decoding and video encoding. Content information is passed as decode and or encode jobs from the MMD 735 to the kernel mode driver 745 through a system of circular or ring buffers. Buffers and surfaces are passed with their virtual address, which is translated into physical address in the kernel mode driver 745. Examples of the content information include information indicating an allocated compressed bitstream buffer, decode surfaces (known as decode context), decode picture buffer, decode target buffer, encode input surface, encode context, and encode output buffer.

The kernel mode 710 also includes a 3D driver 760 and a Platform Security Processor (PSP) 765. The PSP 765 is a kernel mode component that provides cryptographic APIs and methods for decryption and/or encryption of surfaces at the input and output of a compressed bitstream decoder. The PSP 765 also provides the cryptographic APIs and methods at a video encoder output. For example, the PSP 765 can force HDCP 1.4 and 2.x standards for content protection at display physical outputs or virtual displays used for AMD WiFi Display or Microsoft Miracast Session.

Virtualization is a separation of a service request from its physical delivery. It can be accomplished by using:
Binary translation of OS requests between a Guest OS and hypervisor (or VMM) running on a top of host computer hardware layer.
OS assisted paravirtualization where the guest OS communicates to the hypervisor all requests to underline hardware, Hypervisor provides software interfaces for memory management, interrupt handling and time management.
Hardware assisted virtualization with AMD-v technology that allows the VMM to run at elevated privilege level, below kernel mode driver. Hypervisor or VMM that runs on a top hardware layer is known as bare metal type 1 hypervisor. If it runs on a top of a native (host) OS, then it is known as Type 2 Hypervisor.

Virtualization is used in computer client and server systems. Virtualization allows different OSs (or guest VMs) to share multimedia hardware resources (hardware IP) in a seamless and controlled manner. Each OS (or guest VM) is unaware of the presence of other OSs (or guest VMs) within the same computer system. In order to reduce number of interrupts to the main CPU, sharing and coordination of workloads from different guest VMs is managed by a multimedia hardware scheduler. In client-based virtualization, the host OS shares the GPU and multimedia hardware between guest VMs and user applications. Server use cases include desktop sharing over virtualization (screen data H.264 compression for reduced network traffic), cloud gaming, virtual desktop interface (VDI) and sharing of compute engines. Desktop sharing closely ties to use of VCN video encoder.

Single Root I/O Virtualization (SR-IOV) is an extension of PCI express specifications that allows subdivision of accesses to hardware resources by using a PCIe physical function (PF) and one or more virtual functions (VFs). The physical function is used under native (host OS) and its drivers. Some embodiments of the physical function are implemented as a PCI Express function that includes the SR-IOV capability for configuration and management of the physical function and the associated virtual functions, which are associated with the corresponding physical function and are enabled under virtualized environment. Virtual functions allow sharing system memory, graphics memory (frame buffer), and various devices (hardware IP blocks). Each virtual function is associated with a single physical function. The GPU exposes one physical function as per PCIe standard and PCIe exposure depends on a type of OS environment.
In a native (host OS) environment, a physical function is used by native user mode and kernel mode drivers and all virtual functions are disabled. All GPU registers are mapped to the physical function via trusted access.
In a virtual environment, the physical function is used by a hypervisor (host VM) and the GPU exposes a certain number of virtual functions as per PCIe SR-IOV standard, such as one virtual function per guest VM. Each virtual function is mapped to the guest VM by the hypervisor. Only a subset of registers is mapped to each virtual function. Register access is limited to one guest VM at a time, i.e. limited to an active guest VM, where access is granted by the hypervisor. An active guest VM that has been granted access by the hypervisor is referred to as being “in focus.” Each guest VM has access to a subset of a set of registers that are partitioned to include a frame buffer, context registers, and a doorbell aperture used for VF-PF synchronization. At any given time, only one guest VM that is in focus is allowed to do graphics rendering over its own partition of a frame buffer. Other guest VMs are denied access. Each virtual function has its own System Memory (SM) and GPU Frame Buffer (FB). Each guest VM has its own user mode driver and firmware image (i.e. each guest VM runs its own firmware copy for any multimedia function (camera, audio, video decode and/or video encode). To enforce ownership and control of hardware resources, the hypervisor uses CPU MMU and device IOMMU.

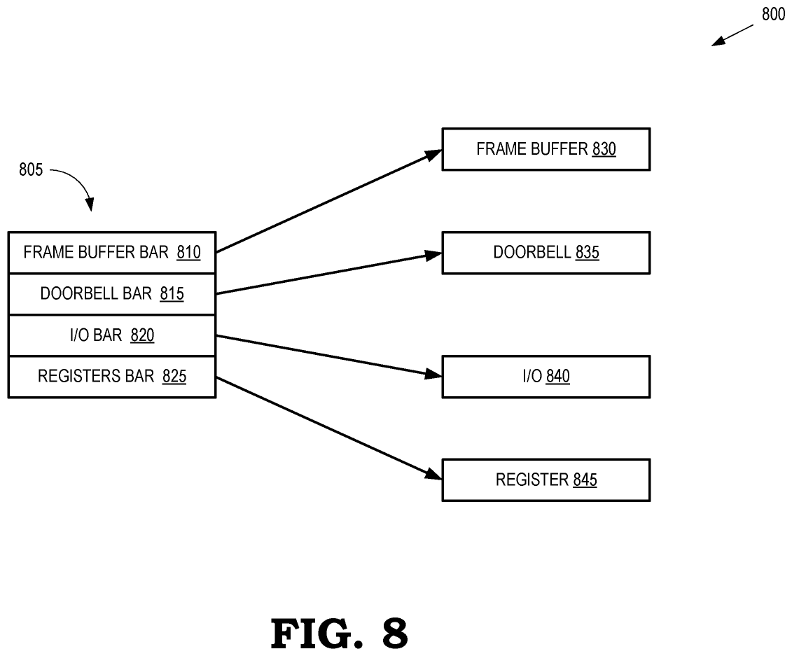

FIG. 8 is a block diagram of a physical function configuration space 800 that identifies base address registers (BAR) for physical functions according to some embodiments. The physical function configuration space 800 includes a set 805 of physical function BARs including a frame buffer BAR 810, a doorbell BAR 815, an I/O BAR 820, and a register BAR 825. The configuration space 800 maps the physical function BARs to specific registers. For example, the frame buffer BAR 810 maps to the frame buffer register 830, the doorbell BAR 815 maps to the doorbell register 835, the I/O BAR 820 maps to the I/O space 840, and the register BAR 825 maps to the register space 845.

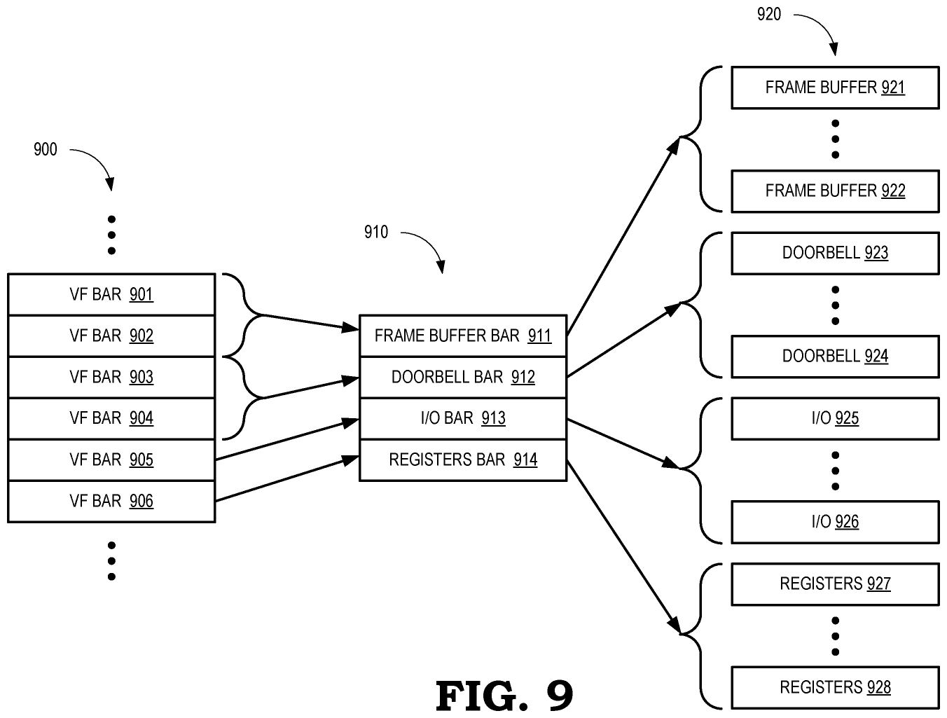

FIG. 9 is a block diagram of a portion 900 of a single root I/O virtualization (SR-IOV) header that identifies BARs for virtual functions according to some embodiments. The portion 900 of the SR-IOV header includes fields holding information identifying the virtual function BARs that are available for allocation to corresponding guest VMs executing on a processing system. In the illustrated embodiment, the portion 900 indicates virtual function BARs 901, 902, 903, 904, 905, 906, which are collectively referred to herein as the virtual function BARs 901-906. The mapping indicated by the virtual function BARs 901-906 in the portion 900 is used to partition a set of registers into subsets associated with different guest VMs.

In the illustrated embodiment, the information in the portion 900 maps to BARs in a set 910 of SR-IOV BARs. The set includes a frame buffer BAR 911, a doorbell BAR 912, an I/O BAR 913, and a register BAR 914, which include information that points to corresponding subsets of registers in a set 920 of registers. The set 920 is partitioned into subsets that are used as a frame buffer, a doorbell, and context registers for corresponding guest VMs. In the illustrated embodiment, the frame buffer BAR 911 includes information that identifies subsets of the registers (which are also referred to as apertures) that include registers to hold the frame buffers 921, 922 for the guest VMs. The doorbell BAR 911 includes information that identifies subsets of the registers that include registers to hold the doorbells 923, 924 for the guest VMs. The I/O BAR 913 includes information that identifies subsets of the registers that include registers to hold the I/O space 925, 926 for the guest VMs. The register BAR 914 includes information that identifies subsets of the registers that include registers to hold the context registers 927, 928 for the guest VMs.

Regarding the frame buffer apertures that includes the frame buffers 921, 922, in some embodiments an actual size of the frame buffer is larger than the size that is exposed through the VF BARs 901-906 (or PF BARs 805 shown in FIG. 8), a private GPU-IOV capability structure is introduced in PCI configuration space as a communication channel for the hypervisor to interact with GPU for partitioning the frame buffer. With the GPU-IOV structure, the hypervisor can assign different sizes of frame buffers to each of the virtual functions, which is referred to herein as frame buffer partitioning.

The GPU doorbell is a mechanism for an application or driver to indicate to a GPU engine that it has queued work on an active queue. Doorbells are issued from the software running on the CPU or on the GPU. On the GPU, a doorbell can be issued by any client that can generate a memory write, e.g., by the CP (command processor), SDMA (system DMA engine), or the CU (compute units). In some embodiments, a 64-bit doorbell BAR 912 points to the start address of doorbell aperture for the virtual functions associated with a physical function. Within a doorbell aperture each ring used for command submissions has its own doorbell register 923, 924 to signal by interrupt that the content of ring buffer has changed. An interrupt is served by the video CPU (VCPU) and a decoding or encoding job is removed from the ring buffer and processed by the CPU, which begins the video decoding or video encoding process on dedicated decode or encode hardware in response to the interrupt.

Registers are divided into four classes:
Hypervisor-only registers can only be accessed by hypervisor. They are the mirror of the GPU-IOV register in the PCIe configuration space.
PF-only registers can only be accessed by a physical function. Any read from a virtual function returns zero; any write from a virtual function is dropped. Display controller and memory controller registers are PF-only.
PF or VF registers can be accessed by both virtual and physical functions, but a virtual-function-only physical function can access such registers only when the virtual function or physical function becomes active function and therefore owns the GPU. The register setting for a physical function or virtual function is in effect only when that function is the active function. When a physical function of the virtual function is active, such register is not accessible by the corresponding driver.
PF and VF Copy registers can be accessed by both physical functions and virtual functions; each virtual function or physical function has its own register copies. The register settings in different functions can be in effect concurrently. Interrupt registers, VM registers, and index/data registers belong to PF and VF Copy category.

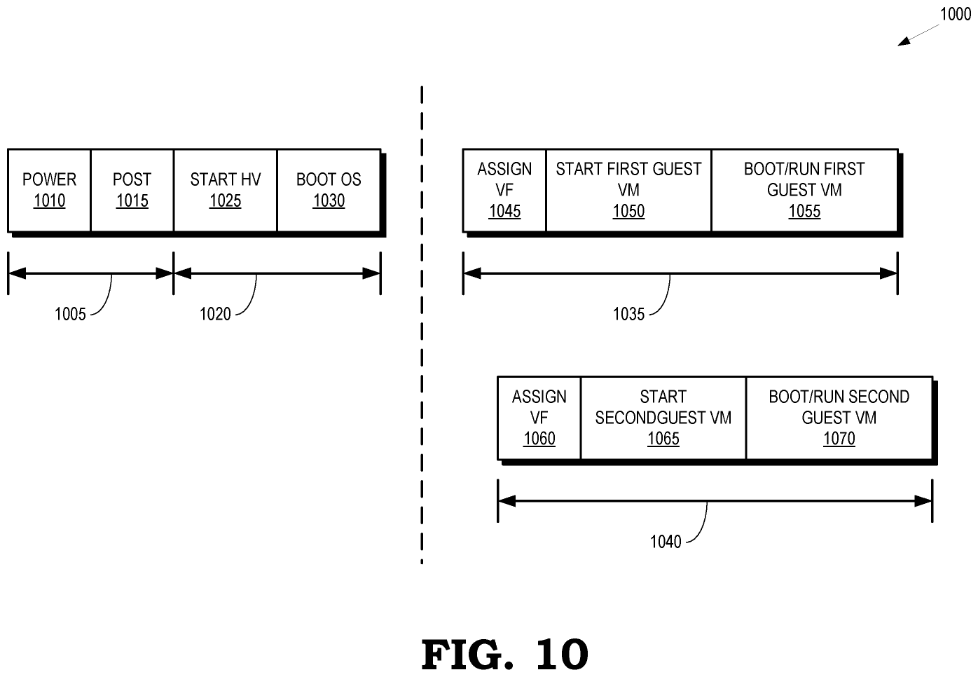

FIG. 10 is a block diagram of a lifecycle 1000 of a host OS that implements a physical function and guest VMs that implement virtual functions associated with the physical function according to some embodiments. In some embodiments, a graphics driver carries embedded firmware images for the following entities:
SMU (system management unit)
MC (memory controller)
ME (micro engine—Copy Graphics)
PFP (pre-fetcher parser—CPF)
CE (constant engine—CP)
compute (compute engine)
System DMA (sDMA)
RLC_G
DMIF (display manage interface)
UVD, VCE, VCN and PSP/SAMU security.

Firmware images for the SMU, MC, and RLC_V are loaded at vBIOS power on self test (POST) time, while other firmware images are loaded by the graphics driver during ASIC initialization and before any of the related firmware engines is used under SR-IOV virtualization.

A system BIOS phase 1005 includes a power up block 1010 and a POST block 1015. During the power up block 1010, the GPU reads the corresponding fuses or straps to determine the BAR size for virtual functions. For example, the GPU can read the sizes REG BAR (32b), FB BAR (64b), DOORBELL BAR (64b). In this case, IO_BAR is not supported in the virtual functions. During the POST block 1015, the system BIOS recognizes the GPU's SR-IOV capability and handshakes with GPU to determine the BAR size for each of the virtual functions. In response to determining the size requirement, the system BIOS allocates enough contiguous MMIO (Memory Mapped I/O) space to accommodate the total BAR size for the virtual functions, in addition to the normal PCI configuration space range requirement for the physical function. Next, system BIOS enables the ARI capability in the root port and the ARI Capable Hierarchy bit in the SR-IOV cap for the physical function.

A hypervisor, OS boot up, and driver initialization phase 1020 includes a hypervisor initialization/startup block 1025, and a host OS boot up block 1030. In the block 1025, the hypervisor starts to initialize a virtualization environment before loading host OS as its user interface. When the host OS (or part of hypervisor) starts, it will load in a GPUV driver that controls the hardware virtualization GPU. In response to loading the GPUV driver, the GPUV driver executes POST VBIOS to initialize the GPU at block 1030. During the VBIOS POST, the driver loads firmware (FW) including PSP FW, SMU FW, RLC_V FW, RLC_G FW, RLC save/restore list, SDMA FW, scheduler FW, and MC FW. Video BIOS reserves its own space in the frame buffer at the end of the frame buffer for PSP to copy and authenticate the firmware. After VBIOS POST, GPUV driver can enable SR-IOV and configure resources of one or more virtual functions and corresponding virtual function phases 1035, 1040.

In the first virtual function phase 1035, the hypervisor assigns a first virtual function to a first guest VM at block 1045. Once the SR-IOV is enabled, a location of a first frame buffer is programmed for the first virtual function. For example, a first subset of a set of registers is allocated to the first frame buffer of the first virtual function. At block 1050, the first guest VM is initialized and a guest graphics driver initializes the first virtual function. The first virtual function responds to PCIe requests to access the frame buffer and other activities. In the last phase, when the first guest VM is assigned the first virtual function as a pass through device, the guest VM recognizes the virtual function as a GPU device. Graphics drivers handshake with GPUV driver and finish the GPU initialization of the virtual function. Once the initialization finishes, the first guest VM boots to predefined desktop at block 1055. The end user can now login to the first guest VM through a remote desktop protocol and start performing desired work on the first guest VM.

In the second virtual function phase 1040, the hypervisor assigns a second virtual function to a second guest VM at block 1060, initializes the second guest VM at block 1065, and the second guest VM boots at block 1070. At this point, there are multiple virtual functions and corresponding guest VMs concurrently running on the GPU. The hypervisor schedules the time slices to the running VM-VFs on the GPU. The selection of a guest VM to run subsequent to a currently executing guest VM, i.e. a GPU switch, is achieved either by hypervisor or by a GPU scheduling switch. When a virtual function obtains its time slice on the GPU, the corresponding guest VM owns the GPU resource and the graphics driver which is running within this guest VM behaves as if it owns the GPU solely. The guest VM response to all command submission and register accesses during its allocated time slice.

In processing units that do not contain Multimedia Scheduler (MMSCH), programming of multimedia engines and their lifecycle control is accomplished by the main x64 or x86 CPU. In such mode, video encode, and/or video decode firmware loading and initialization is accomplished by the virtual function driver, at the time when it is initially loaded. At run time, each loaded virtual function instance has its own firmware image and performs firmware and register context restore, retrieval of only one job from its own queue, encodes a full frame and performs context save. When the virtual function instance reaches the idle time, it notifies the hypervisor that the hypervisor may load the next virtual function.

If present, the MMSCH assumes and takes over the CPU role in managing multimedia engines. It performs initialization and setup of the virtual functions, context save/restore, job submissions in the guest VM to the virtual function with doorbell programming, and performs a reset of the physical function and virtual functions, as well as handling error recovery. Some embodiments of the MMSCH are implemented as a firmware on a low power VCPU. Firmware for MMSCH and MMSCH initialization is performed by the Platform Security Processor (PSP) whose firmware is contained in the video BIOS (vBIOS). The PSP downloads a MMSCH firmware image by using an ADDRESS/DATA register pair with autoincrementing, programs its configuration registers and brings the MMSCH firmware image out of reset. Once the MMSCH is running, the hypervisor performs a setup of multimedia virtual functions through programming SR-IOV and GPU-IOV capabilities. The hypervisor configures the BARs for the physical functions and virtual functions, performs multimedia initialization in the guest VMs and enables the guest VMs to run sequentially. Multimedia initialization requires memory allocation in each guest VM to hold VCE and UVD (or VCN) virtual registers and corresponding firmware. The hypervisor then programs registers for the VCE/UVD or VCN hardware by setting up addresses and sizes of apertures where firmware is loaded. The hypervisor also sets up registers that define address start and size of a stack for a firmware engine and their instruction and data caches. The hypervisor then programs the local memory interface (LMI) configuration registers and removes reset from a corresponding VCPU.

Some embodiments of the MMSCH perform the following activities:
Multimedia Engine Initialization for PF and VF functions. With bare metal platform, driver initializes the VCE or UVD engine through direct MMIO register read/write. Under virtualization, MM engine virtualization has the capability to work on one function's job while the other function is undergoing initialization. This capability is supported by submitting an initialization memory descriptor to the MMSCH, that will schedule and trigger multimedia engine initialization for a VF at later time when the first command submission happens.
Multimedia Command Submission for the PF and VF functions. With bare metal platform, the command submission for VCE and UVD (or VCN) is through MMIO WPTR registers such as VCE_RB_WPTR. Under virtualization, the command submission switches to doorbell write which is like GFX, SDMA, and Compute command submission. To submit a command package to a ring/queue, GFX driver writes to a corresponding doorbell location. Upon the write to the doorbell location, the MMSCH receives a notification for this VF and ring/queue. The MMSCH saves such information internally for each function and ring/queue. When this function becomes the active function, the MMSCH informs the corresponding engine to start processing the accumulated command packages for the ring/queue.
Multimedia World Switch means switching between a currently running multimedia VF instance to the next multimedia VF instance. Multimedia World Switch is accomplished with the several commands exchanges between MMSCH firmware and UVD/VCE/VCN firmware of the currently running and next to run multimedia firmware instance. Commands are exchanges via simple INDEX/DATA common register set found in MMSCH and VCE/UVD/VCN. In some embodiments, the following commands exist:
   gpu_idle (fcn_id)—MM engine is asked to stop processing any command on current function. If the MM engine is currently working on the function, the MMSCH waits until the MMSCH receives the current job completion from the MM engine, stops any further processing any stop any further commands for this function; otherwise the MMSCH returns the command completion immediately.
   gpu_save_state (fcn_id)—the MMSCH saves the engine states of the current function fcn_id to the context saving area.
   gpu_load_state (fcn_id)—the MMSCH loads the engine state of function (fcn-id) from the context SRAM area to engine registers.
   gpu_run (fcn_id)—the MMSCH notifies the MM engine to start processing jobs (commands) for the function (VFID=fcn_id).
   gpu_context_switch (fcn_id, nxt_fcn_id)—the MMSCH waits for the MM engine to finish processing a job on function VFID=fcn_id and switches to process the job on the next function specified by nxt_fcn_id argument.
   gpu_enable_hw_autoscheduling (active_functions)—this command notifies the MMSCH to perform a world switch between the VM functions which are listed in the register array. During the MM engine world switch, each function in the list remains active for the time slice specified by register.
   gpu_init (fcn_id)—this command notifies the MMSCH that the engine for a specific function (fcn_id) will undergo initialization.
   gpu_disable_hw_autoscheduling (active_functions)—this command notifies the MMSCH to stop performing the MM engine world switch for the function listed. Upon receiving this command, the MMSCH waits for the current active function finishes its job (frame), then executes gpu_idle and gpu_save_state commands and stays at the current active function for a further operation.
   gpu_disable_hw_scheduling_and_context_switch—this command asks the MMSCH to stop performing the world switch. Upon receiving this command, the MMSCH waits for the current active function finish its job, then executes gpu_context_switch command to switch to the next function for further operation.
Multimedia Page Fault Handling under bare metal, when UVD or VCE command execution encounters page fault, MC/VM notifies UVD/VCE HW block about the page fault and raises an interrupt to host. After that, UVD/VCE and KMD perform the following:
   When UVD receives the page fault notification, it notifies UVD firmware through internal interrupt with the ring/queue which causes the page.
   The UVD firmware drains (drops) all request for this ring/queue.
   The UVD firmware then resets the engine and reboots the VCPU.
   After the VCPU reboot, the UVD firmware polls for any new command in its own ring buffer.
   When KMD receives the page fault interrupt, KMD will read the multimedia status register to find out which ring/queue has page fault. After retrieving the page fault ring info, KMD will reset the read/write pointer of the faulty ring/queue to zero and indicate UVD/VCE/VCN firmware the page fault error has been handled so that FW can continue/start processing the submitted command again.
   In the above handling scheme, the handshake between UVD/VCE firmware and KMD driver is through UVD PF STATUS and VCE PAGE FAULT STATUS registers.
   Under SR-IOV virtualization, the page fault handshake scheme is memory location based since there is no other PF and VF register to depend on.

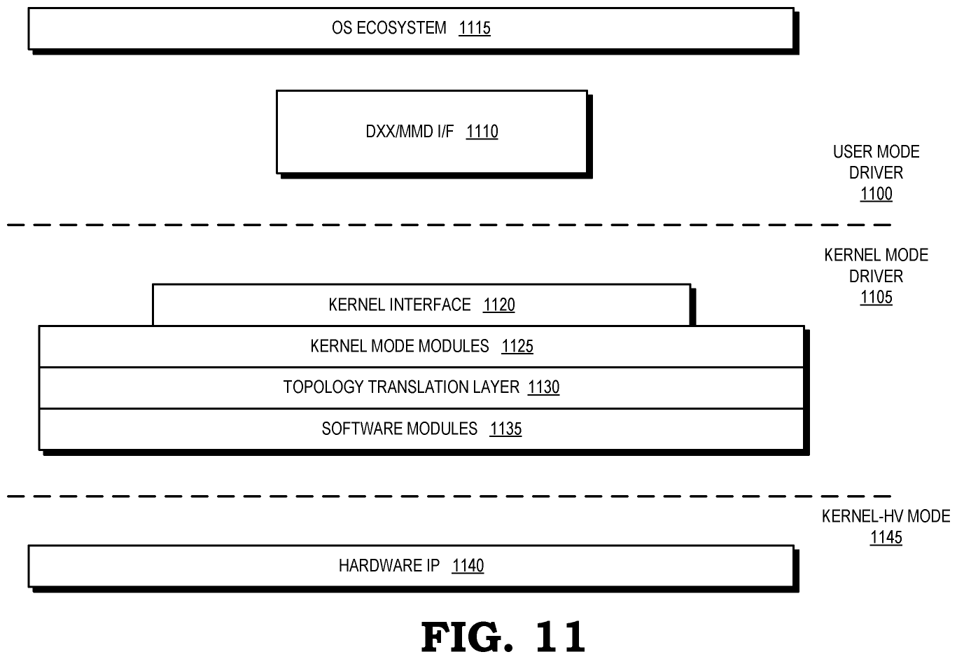

FIG. 11 is a block diagram of a multimedia user mode driver 1100 and a kernel mode driver 1105 according to some embodiments. Hardware accelerators such as VCE/UVD/VCN engines have limited decoding and encoding bandwidth and therefore the hardware accelerators are not always able to properly serve all of the enabled virtual functions during run time. Some embodiments of processing units such as a video GPU arrange or assign the VCE/UVD/VCN encode or decode engine bandwidth to particular virtual functions based on a profile of the corresponding guest VM. If the profile of the guest VM indicates that a video encode bandwidth is required, the GPU generates a message that is passed down to the virtual function through a mailbox register before a graphics driver starts to initialize the virtual function. In addition, the GPU also notifies a scheduler of the virtual function bandwidth requirement before the virtual function starts any job submission. For example, a VCE is capable of H.264 video encoding with maximum bandwidth of about 2M MB per second—one MB equals to 16×16 pixels. The maximum bandwidth information is stored in a Video BIOS table along with maximum surface width and height (for example 4096×2160). During initialization, a GPU driver retrieves the bandwidth information as the initial total available bandwidth to manage the encode engine bandwidth assignment. Some embodiments of the GPU convert bandwidth information into the profiles/partitions.

In the illustrated embodiment, the multimedia user mode driver 1100 and kernel mode driver 1105 are multilayered and structured by functional blocks. In operation, the multimedia user mode driver 1100 includes an interface 1110 to the operating system (OS) ecosystem 1115. Some embodiments of the interface 1110 include software components such as interfaces to different graphics pipeline calls. For example, the multimedia user mode driver 1100 uses UDX and DXX interfaces implemented in the interface 1110 when allocating surfaces of various size and in various color spaces and tiling formats. In some cases, the multimedia user mode driver 1100 also has direct DX9 and DX11 video DDI interface shows implemented in the interface 1110. The multimedia user mode driver 1100 also implements a private API set used for interfacing with a media foundation, such as the mf 730 shown in FIG. 7, which provides an interaction interface to other media APIs and frameworks, e.g., in Windows, Linux, and Android OS ecosystems. Some embodiments of the multimedia user mode driver 1100 use events displaced from external components (e.g., the AMF and AMD UI CCC control panel). The multimedia user mode driver 1100 also implements a set of utility and helper functions that allow OS independent use of synchronization objects (flags, semaphores, mutexes), timers, networking socket interface, video security, and the like. Some embodiments of the bottom inner structure of the multimedia user mode driver 1100 are organized around core base class objects written in C++. A multimedia core implements set of base classes that are OS and hardware independent and that provides support for:
Compressed bitstream video decode supporting multiple CODECs and video resolutions
Video encoding from surfaces in YUV or RGB color space to H.264, H.265, VP9 and AV1 compressed bitstreams
Video rendering that supports color space conversion and upscaling/downscaling of received or produced surfaces. Other video rendering features like gamut correction, deinterlacing, face detection, skin tone correction exist and are auto-enabled by AMD Multimedia Feature Selector (AFS) and Capability Manager (CM) and they run as shaders on graphics compute engine.

Classes derived for the multimedia user mode driver 1100 are OS specific. For example, there is multimedia core functionality for Core Vista (for Windows OS ecosystem supporting all variants from Windows XP, via Windows 7 to Windows 10), Core Linux, and Core Android. These cores provide portability of the multimedia software stack to other OS environments. Device portability is ensured with a Multimedia Hardware Layer that autodetects underlying devices. Communication with the kernel mode driver 1105 are achieved by IOCTL (escape) calls.

The kernel mode driver 1105 includes a kernel interface 1120 to OS kernel that receives all kernel related device specific calls (such as DDI calls). The kernel interface 1120 includes a dispatcher that dispatches the calls to appropriate modules of the kernel mode driver 1105 that abstract different functionality. The kernel interface 1120 includes an OS manager that controls interactions with OS-based service calls in the kernel. The kernel mode driver 1105 also includes kernel mode modules 1125 such as engine nodes for multimedia decode (UVD engine node), multimedia encode (VCE engine node), and multimedia video codec next (VCN node for APU SOCs). The kernel mode modules 1125 provide hardware initialization and allow submission of decode or encode jobs to a system of hardware-controlled ring buffers. A topology translation layer 1130 isolates nodes from services and provides interfacing to software modules 1135 in the kernel mode driver 1105. Examples of the software modules 1135 include swUVD, swVCE, and swVCN, which are hardware specific modules that provide access to ring buffers for reception and handling of decode or encode jobs, control tiling, control power gating, and respond to IOCTL messages received from the user mode driver. The kernel mode driver 1105 also provides access to hardware IP 1140 over a hypervisor in the kernel-HV mode 1145.

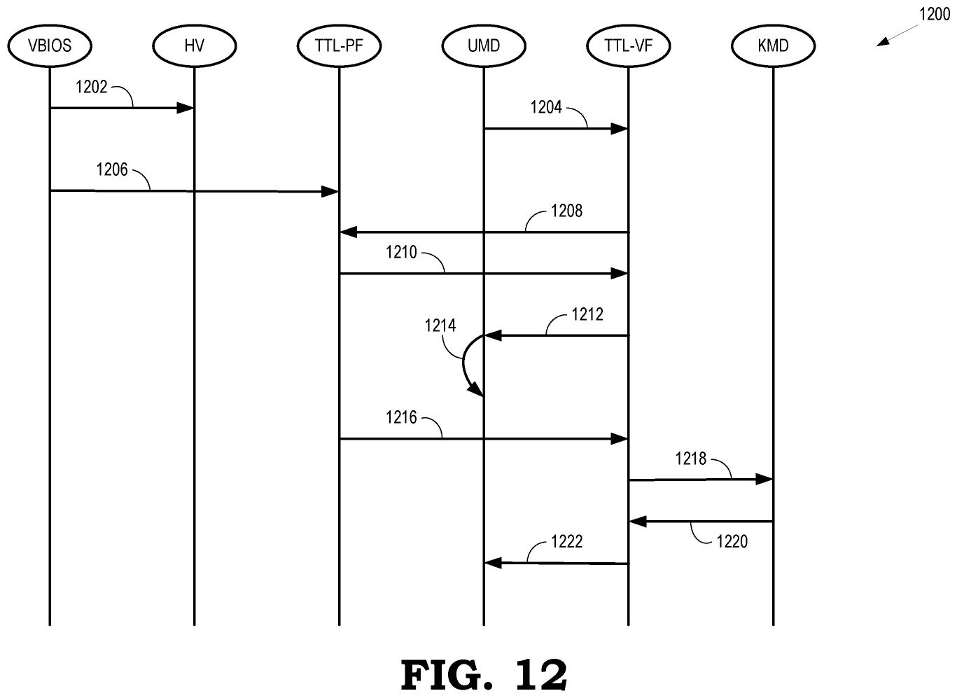

FIG. 12 is a first portion 1200 of a message sequence that supports multimedia capability sharing in a virtualized OS ecosystem according to some embodiments. The message sequence is implemented in some embodiments of the processing system 100 shown in FIG. 1. The first portion 1200 illustrates messages exchanged between a video BIOS (VBIOS), a hypervisor (HV), a kernel mode driver topology translation layer for a physical function (TTL-PF), a multimedia UMD for a virtual function, a kernel mode driver TTL for the virtual function (TTL-VF), and a kernel mode driver (KMD) for the virtual function. Communication between a physical function and a virtual function is accomplished via a mailbox message exchange protocol with doorbell signaling. In some embodiments, the mailbox operates via common register sets, while doorbell signaling allows interrupt-based notification in the physical function or virtual function to occur. In other embodiments, communication is achieved via a local shared memory with doorbell signaling.

The VBIOS determines if the system is SR-IOV capable and, if so, the VBIOS provides (at message 1202) information indicating fragmentation of the frame buffer to the hypervisor. The information can include feature flags indicating the frame buffer subdivisions for UVD/VCE/VCN. Each supported instance of a virtual function associated with the physical function obtains (at message 1204) a record in its own frame buffer that is specific to an auto-identified device. This record indicates Maximum Multimedia Capability such as 1080p60 or 4K30 or 4K60 or 8K24, or 8K60, which is a sum of all activities that can be sustained on a given device. In some embodiments, the bandwidth is exhausted by one virtual function only, employing a decode or encode or both functions. For example, if the total multimedia capability is 4K60, it can support four virtual functions, each doing 1080p60 decoding, or up to ten virtual functions, each doing 1080p24 decoding or two virtual functions each doing 1080p60 decoding and two virtual functions each doing 1080p60 video encoding.

When an application on a guest OS/VM running on a virtual function loads a multimedia driver for either decode or encode use case, the loaded multimedia driver becomes aware of the current encode or decode profile and sends a request to a TTL layer of a KMD driver (in message 1206). This request can be formulated as either:
1) A current resolution of decode or encode operation indicating horizontal and vertical size and refresh rate of source (say 720p24, 108030, etc.) or
2) A total number of macroblocks in encoded frames or in compressed bitstream content that needs to be decoded

The TTL-VF in a current virtual function receives a request and forwards it to a TTL layer of a physical function (a message 1208). The TTL-PF is aware of maximum decode or encode bandwidth and has a record of multimedia utilization of each virtual function.

If the encode or decode capability is not available, the PF TTL notifies the TTL-VF (via message 1210), which then notifies the UMD in the same virtual function (via message 1212). In response to the message 1212, the UMD fails application request to load Multimedia driver in the virtual function and application closes at activity 1214.

If the encode or decode capability is available, the PF TTL updates its bookkeeping records and notifies the TTL-VF (via message 1216), which sends a request (via message 1218) to the KMD to download firmware, open and configure UVD/VCE or VCN multimedia engine (at message 1218). The KMD then becomes able to run and the KMD node in a virtual function then notifies TTL-VF that is able to accept the first job submission (at message 1220). In response to the message 1220, the TTL-VF notifies the UMD for the virtual function that its configuration process has completed (at message 1222).

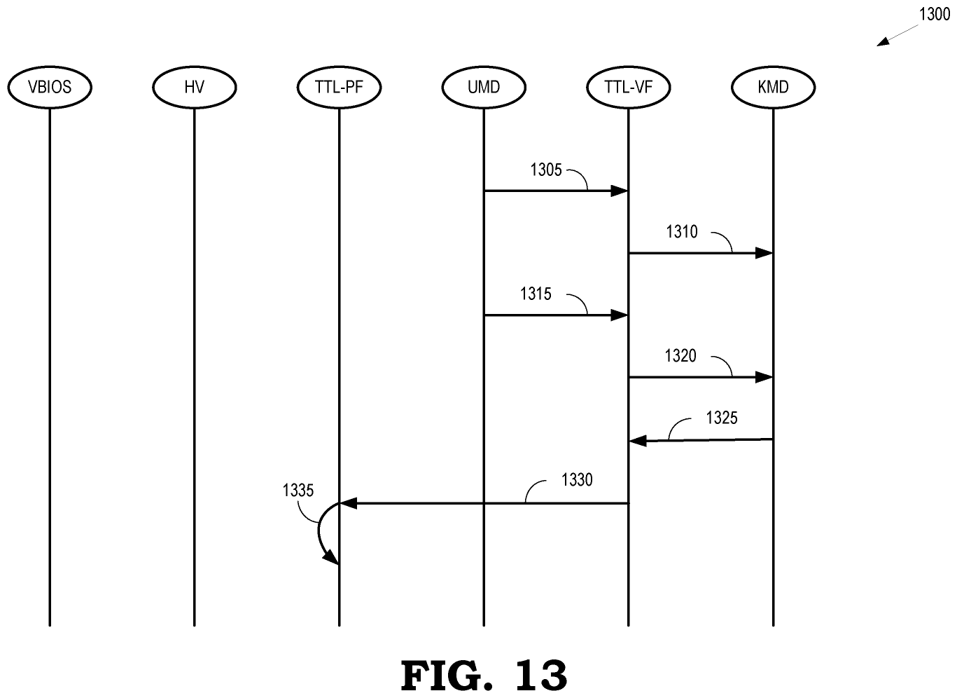

FIG. 13 is a second portion 1300 of the message sequence that supports multimedia capability sharing in a virtualized OS ecosystem according to some embodiments. The second portion 1300 of the message sequence is implemented in some embodiments of the processing system 100 shown in FIG. 1 and is performed subsequent to the first portion 1200 shown in FIG. 12. The second portion 1300 illustrates messages exchanged between a video BIOS (VBIOS), a hypervisor (HV), a kernel mode driver topology translation layer for a physical function (TTL-PF), a multimedia UMD for a virtual function, a kernel mode driver TTL for the virtual function (TTL-VF), and a kernel mode driver (KMD) for the virtual function.

During normal runtime operation, a multimedia application (e.g., the UMD) in a selected time interval submits an encode or decode job request to TTL-VF (via the message 1305), which notifies an appropriate node to submit and execute the requested job by transmitting the message 1310 to the KMD.

During the last step of the application lifecycle on the guest VM, the application issues a request to a multimedia driver at the TTL-VF to close. The TTL-VF forwards the request to the TTL-VF via message 1315. The TTL-VF issues (via message 1320) a closing request to a corresponding multimedia node, which notifies (via message 1325) the TTL-VF that a node has been closed. Upon successful deactivation of multimedia node, the TTL-VF signals (via message 1330) the TTL-PF, which then reclaims the encoding or decoding bandwidth and updates its bookkeeping records (at activity 1335).

Upon completion of one submitted job for a virtual function, the TTL-VF signals the multimedia scheduler that a job has been executed on the virtual function. The multimedia scheduler deactivates the virtual function. The multimedia scheduler then performs a world switch to a next active virtual function. Some embodiments of the multimedia scheduler use a round robin scheduler to activate and serve virtual functions. Other embodiments of the multimedia scheduler use dynamic priority-based scheduling where priorities are evaluated based on a type of a queue used by the corresponding virtual function. In yet other embodiments, the multimedia scheduler implements a rate monotonic scheduler serving guest VMs that have decode or encode jobs of lower resolutions (e.g., shorter job intervals) than the guest VMs that are using the priority based queue system, e.g., a time critical queue for an encode job for a Skype application with a minimal latency, or a real time queue for encode job for a wireless display session, a general purpose encode queue for a non-real time video transcoding, or a general purpose decode queue.

Some embodiments of the message sequence disclosed in FIGS. 12 and 13 support sharing of one multimedia hardware engine among many virtual functions serving each Guest OS/VM. This creates an impression that each Guest OS/VM has its own dedicated multimedia hardware, though one hardware instance is shared to serve many virtual clients. In the most simplistic case, the number of virtual functions is two that allow Host and Guest OS to concurrently run hardware accelerated video decode or hardware accelerated video encode. In yet another embodiment, as many as sixteen virtual functions are supported, although other embodiments support more or fewer virtual functions.

Some embodiments of the message sequence disclosed in FIGS. 12 and 13 are used in various computer client and server systems. In client-based virtualization, a host OS shares the GPU and multimedia hardware intellectual property (IP) blocks between virtual machines (VMs) and user applications. Server use cases include desktop sharing (captured screen data is H.264 compressed for reduced network traffic), cloud gaming, virtual desktop interface (VDI) and sharing of compute engines.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A processing unit comprising:
a kernel mode unit configured to execute a hypervisor and guest virtual machines (VMs);
a fixed function hardware block configured to implement a physical function, wherein virtual functions corresponding to the physical function are exposed to the guest VMs; and
a set of registers, wherein subsets of the set of registers are allocated to store information associated with the virtual functions, and wherein the fixed function hardware block executes one of the virtual functions for one of the guest VMs based on the information stored in a corresponding one of the subsets.

2. The processing unit of claim 1, wherein the set of registers is partitioned into a number of subsets that corresponds to a maximum amount of space allocated to the virtual functions.

3. The processing unit of claim 1, wherein the set of registers is initially partitioned into a number of subsets that corresponds to a minimum amount of space allocated to the virtual functions, and wherein the number of the subsets is subsequently modified based on properties of the virtual functions.

4. The processing unit of claim 1, wherein each subset of the set of registers includes a frame buffer to store frames that are operated on by the virtual function associated with the subset, context registers to define an operating state of the virtual function, and a doorbell to signal that the virtual function is ready to be scheduled for execution.

5. The processing unit of claim 4, further comprising:
a scheduler configured to schedule a first guest VM of the guest VMs to execute a first virtual function of the virtual functions in a first time interval in response to signaling from the first guest VM.

6. The processing unit of claim 5, wherein the hypervisor grants the first guest VM access to a first subset of the set of registers during the first time interval, and wherein the hypervisor denies unscheduled guest VMs access to the set of registers during the first time interval.

7. The processing unit of claim 6, wherein the fixed function hardware block is configured to execute the first virtual function based on information stored in first context registers in the first subset of the set of registers.

8. The processing unit of claim 7, wherein at least one of a user mode driver and a firmware image of multimedia functionality used to implement the first virtual function are installed on the fixed function hardware block.

9. The processing unit of claim 7, wherein the first guest VM writes information to a doorbell register in the first subset to signal to the scheduler that the first guest VM is ready to be scheduled for execution.

10. The processing unit of claim 9, wherein the first guest VM is scheduled based on a priority associated with the guest VM and other priorities associated with other guest VMs that are ready to be scheduled.

11. The processing unit of claim 9, wherein the first guest VM performs graphics rendering on frames stored in a frame buffer in the first subset using the first virtual function during the first time interval.

12. The processing unit of claim 11, wherein the first guest VM notifies the hypervisor in response to completing execution during the first time interval, and wherein the doorbell register in the first subset is cleared in response to completing execution during the first time interval.

13. A method comprising:
receiving, at a hypervisor and from a first guest virtual machine (VM) executing in a processing unit, a request to access a first virtual function corresponding to a physical function implemented on a fixed function hardware block in the processing unit;
granting, from the hypervisor and to the first guest VM, access to a first subset of a set of registers in the processing unit, wherein the first subset stores information associated with the first virtual function;
configuring the fixed function hardware block to execute the first virtual function for the first guest VM based on the information stored in the first subset; and
performing, using the first guest VM, graphics rendering on frames stored in the first subset using the fixed function hardware block configured to implement the first virtual function.

14. The method of claim 13, further comprising:
partitioning the set of registers into a number of subsets that corresponds to a maximum amount of space allocated to the virtual functions.

15. The method of claim 13, further comprising:
partitioning the set of registers into a number of subsets that corresponds to a minimum amount of space allocated to the virtual functions; and
modifying the number of the subsets based on properties of the virtual functions.

16. The method of claim 13, wherein the first subset of the set of registers includes a frame buffer to store the frames that are operated on by the first virtual function, context registers to define an operating state of the virtual function, and a doorbell register to signal that the virtual function is ready to be scheduled for execution.

17. The method of claim 16, further comprising:
scheduling a first guest VM to execute the first virtual function in a first time interval in response to signaling from the first guest VM.

18. The method of claim 17, further comprising:
granting, from the hypervisor, the first guest VM access to the first subset of the set of registers during the first time interval, and wherein the hypervisor denies unscheduled guest VMs access to the subsets of the set of registers during the first time interval.

19. The method of claim 18, wherein configuring the first virtual function comprises installing at least one of a user mode driver and a firmware image of multimedia functionality used to implement the first virtual function on the fixed function hardware block.

20. The method of claim 18, further comprising:
writing, from the first guest VM, information to the doorbell register in the first subset to signal that the first guest VM is ready to be scheduled for execution.

21. The method of claim 20, wherein scheduling the first guest VM comprises scheduling the first guest VM in response to reading the information from the doorbell register.

22. The method of claim 21, wherein scheduling the first guest VM comprises scheduling the first guest VM based on a priority associated with the first guest VM and other priorities associated with other guest VMs that are ready to be scheduled.

23. The method of claim 21, wherein performing the graphics rendering on the frames comprises performing graphics rendering on frames stored in a frame buffer in the first subset using the first virtual function during the first time interval.

24. The method of claim 21, wherein the first guest VM notifies the hypervisor that another virtual function can be loaded for another guest VM in response to completing execution during the first time interval, and wherein the doorbell register in the first subset is cleared in response to completing execution during the first time interval.

25. A method, comprising:
performing, using a first guest virtual machine (VM) executing on a processing unit, graphics rendering on frames stored in a first subset of a set of registers implemented in the processing unit, wherein the graphics rendering is performed using a first virtual function corresponding to a physical function implemented on a fixed function hardware block that is configured to implement the first virtual function based on first context information stored in the first subset;
detecting, at a hypervisor, a request from a second guest VM to access a second virtual function corresponding to the physical function; and
performing, at the hypervisor and in response to the request, a world switch to configure the fixed function hardware block to execute the second virtual function.

26. The method of claim 25, wherein the second guest VM writes information to a doorbell register in a second subset of the set of registers to indicate that the second guest VM is ready to be scheduled, and wherein detecting the request comprises reading the information from the doorbell register.

27. The method of claim 26, further comprising:
scheduling the second guest VM for execution during a time interval that begins at a scheduled time in response to detecting the request.

28. The method of claim 27, wherein scheduling the second guest VM for execution during the time interval comprises granting the second guest VM exclusive access to the set of registers during the time interval.

29. The method of claim 27, wherein performing the world switch comprises performing the world switch at the scheduled time.

30. The method of claim 29, wherein performing the world switch comprises configuring the fixed function hardware block based on second context information stored in the second subset of the set of registers.

31. The method of claim 30, wherein configuring the fixed function hardware block comprises installing at least one of a user mode driver and a firmware image of multimedia functionality used to implement the second virtual function.

32. The method of claim 30, further comprising:
performing, using the second guest VM, graphics rendering on frames stored in the second subset of the set of registers using the second virtual function.
